(19) United States
(12) Patent Application Publication
(10) Pub. No.: US 2014/0067645 A1
(43) Pub. Date: Mar. 6, 2014

(54) SYSTEM AND METHOD FOR MANAGING INFORMATION RELATED TO SPATIALLY RESOLVED UNITS

(71) Applicant: Globooz AG, Zurich (CH)

(72) Inventor: Roman Gulyaev, Saint-Petersburg (RU)

(73) Assignee: Globooz AG, Zurich (CH)

(21) Appl. No.: 14/012,572

(22) Filed: Aug. 28, 2013

Related U.S. Application Data
(60) Provisional application No. 61/694,040, filed on Aug. 28, 2012.

(51) Int. Cl. G06Q 40/04

(52) U.S. Cl. CPC G06Q 40/04
USPC 705/37

(57) ABSTRACT

A system and method is provided for apportioning and selling non-overlapping virtual overlay territorial units based on a system of coordinates, with accompanying exclusive rights to sell advertising and post information within a geographic area defined by a corresponding virtual overlay territorial unit. The inventive system and method is facilitated by an Internet based platform accessed via a website with a graphical user interface (GUI) is used to present varying views of geographic areas that may range from the entire globe down to unitized areas presented at street level. The platform combines different resources, such as geographical and satellite maps, search engines, instant messaging, news, or social networking, etc., into one application.

### CROSS-REFERENCE TO RELATED APPLICATION

This application claims priority of U.S. Provisional Patent Application Ser. No. 61/694,040 filed Aug. 28, 2012, which is incorporated herein by reference.

### FIELD OF THE INVENTION

The present invention in general relates to electronic commerce and advertising and in particular to apportioning and selling virtual overlay territorial units with accompanying rights to sell advertising and post information within a geographic area defined by a virtual overlay territorial unit.

### BACKGROUND OF THE INVENTION

Electronic commerce, commonly known as e-commerce is the buying, selling, and marketing of products, information, and services over electronic systems such as the Internet and other computer networks. Electronic commerce may also encompass a wider range of technologies such as e-mail, mobile devices and telephones as well. The use of electronic commerce has become increasingly common and may now be found in use in virtually every corner of the world.

Electronic commerce has suffered from a lack of geographic specificity that requires additional consumer effort to locate a local good or service provider, thereby leading to a potential consumer to discard distant sources of commerce that cannot efficiently benefit the consumer. While attempts have been made to use consumer computer IP address or a uniform resource locator (URL) to automatically detect the presence of an inquiring computer, these attempts have met with limited acceptance as requiring additional information input from the consumer or automatic IP address detection. However, with the ever increasing use of remote servers and the use to purchase goods or services in a specific location remote from the consumer computer at a given time.

The surface area of Earth is approximately 510 million square kilometers (200 million square miles) of which approximately 149 million square kilometers (29.2%) is land.

A geographic coordinate system enables every location on the Earth to be specified by a set of numbers and/or letters. The coordinates are often chosen such that one set of the numbers represent vertical position, and two, or three of the numbers represent horizontal position. A common choice of coordinates is latitude, longitude, and elevation.

The latitude of a point on the Earth's surface is the angle between the equatorial plane and a line that passes through that point and is normal to the surface of a reference ellipsoid which approximates the shape of the Earth. This line passes a few kilometers away from the center of the Earth except at the poles and the equator where the line passes through Earth's center. Lines joining points of the same latitude trace circles on the surface of the Earth called parallels, as they are parallel to the equator and to each other. The North Pole is 90° N; the South Pole is 90° S. The 0° parallel of latitude is designated the equator. The equator divides the globe into Northern and Southern Hemispheres.

The Longitude of a point on the Earth's surface is the angle east or west from a reference meridian to another meridian that passes through that point. All meridians are halves of great ellipses, which converge at the north and south poles. A line passing near the Royal Observatory, Greenwich, England has been chosen as the international zero-longitude reference line, the Prime Meridian. Places to the east are in the eastern hemisphere, and places to the west are in the western hemisphere. Longitude is given as an angular measurement ranging from 0° at the Prime Meridian to +180° eastward and −180° westward. Each degree of longitude is sub-divided into 60 minutes, each of which is divided into 60 seconds. A longitude is thus specified in sexagesimal notation as 23° 27′ 30″ E. For higher precision, the seconds are specified with a decimal fraction. An alternative representation uses degrees and minutes, where parts of a minute are expressed in decimal notation with a fraction, thus: 23° 27.500′ E. Degrees may also be expressed as a decimal fraction: 23.45833° E. For calculations, the angular measure may be converted to radians, so longitude may also be expressed in this manner as a signed fraction of π (pi), or an unsigned fraction of 2π.

Thus, there exists a need for improved matching and targeting of marketing and advertising of products, services, places, and information to various locations all over the world with resort to the geographic coordinate system.

### SUMMARY OF THE INVENTION

A method is provided for apportioning and selling non-overlapping virtual overlay territorial units based on a system of coordinates, with accompanying exclusive rights to sell advertising and post information within a geographic area defined by a corresponding virtual overlay territorial unit. A system is also provided that implements the method. In embodiments of the inventive system and method, an Internet based platform accessed via a website with a graphical user interface (GUI) is used to present varying views of geographic areas that may range from the entire globe down to unitized areas presented at street level. The platform combines different resources, such as geographical and satellite maps, search engines, instant messaging, news, or social networking, etc., into one application.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exploded perspective view of a geographic area subdivided by a virtual overlay grid defining territorial units in the form of a booz;

FIGS. 2a-2s illustrate a series of screen shots of an embodiment of a graphical user interface (GUI) for implementing aspects of the invention; and

FIG. 3 is a schematic diagram illustrating an overall view of communication devices, computing devices, and mediums for implementing embodiments of the invention.

The detailed description explains the preferred embodiments of the invention.

### DESCRIPTION OF THE INVENTION

The present invention has utility as a system and method for apportioning and selling non-overlapping virtual overlay territorial units based on a system of coordinates, with accompanying exclusive rights to sell advertising and post information within a geographic area defined by a corresponding virtual overlay territorial unit. In embodiments, an Internet based platform accessed via a website with a graphical user interface (GUI) is used to present varying views of geographic areas that may range from the entire globe down to unitized areas presented at street level. The platform combines different resources, such as geographical and satellite maps, search engines, instant messaging, news, or social networking, etc., into one application.

As used herein, a unit area of non-overlapping virtual overlay territory based on a system of coordinates in such a context is defined herein as a booz.

It is appreciated that a booz can be of the same or different area, as compared to other boozes in a given mapping onto the earth geography. In a specific embodiment, a booz is defined as a 1 square kilometer area in the form of a trapezoid, as the globe is not round but has an ellipsoidal shape. It is appreciated that a booz may be defined as a larger or smaller area and having varying shapes. In yet other inventive embodiments, the exact geographic coordinates of the borders of the booz are defined by an underlying formula with the calculated coordinates stored in a database. Each unique booz is identified by a serial number. In still other inventive embodiments, the entire surface area of the Earth including both land and water (lakes, seas, oceans) is sectioned into boozes. It is appreciated that boozes can be defined as contiguous or remote from other boozes.

In other inventive embodiments, a user may purchase an available booz that is has no previous ownership, or through a resale transaction of an occupied booz. Water based boozes may also be used to gain membership to the platform. Upon successfully joining the platform, a user/member is assigned or chooses an identification (ID) and password. The price of a booz may be set or may be determined based on market forces such as demand for a particular booz location. A booz purchase may entail a lump sum payment, as well as a yearly renewal fee. A purchaser of a booz is referred to synonymously as a booz master or a booz owner. Booz ownerships may be traded between members of the platform. Administrators of the platform may be required to approve any sale or transfer of a booz irrespective of whether the purchaser is a current or potential new member to the platform. A booz master may not change the boundaries of a specific booz, as the map is fixed by the platform administrators. Furthermore, members or booz masters are subject to rules and terms and conditions of use of the platform as set by the platform administrators.

In embodiments following a successful purchase or acquisition of a booz, a booz master is entitled to a percentage of revenue generated by advertising within their booz. In an embodiment, a booz master receives 80% share of all advertising generated within their booz, with the remaining 20% going to the platform. It is noted that other commission models and percentages may be paid out, as well as referral fees and incentives within the framework of the platform. In an embodiment, while a booz master finds or sources the advertising within their booz, contracts are entered into directly between the advertiser and the platform administrators. Advertising must conform to standards formed by the platform operator or administrators. In embodiments, a yellow icon or object is used to represent a paid advertising source within a booz. As will be shown further below with reference to the figures, at the object level within the service platform maps of the GUI, booz masters may place white objects indicating the locale of a business (e.g. a restaurant) and add basic information, such as name and place of business, working hours, category, type and keywords, phone number and a brief description about this business. Yellow objects may be created by turning existing white objects into yellow objects or by placing new yellow objects in the map. In order to turn white objects into yellow objects the advertiser has to claim a white object indicating their business or branch of business using a “claim-button” within the white object. Objects are readily sold by a booz owner to a third party. When claimed by the advertiser the white object will turn into a yellow object upon payment of an advertising fee. In certain inventive embodiments, comments may be placed on a yellow object by members of the platform. Yellow objects that are placed on the interactive map of the inventive GUI will be shown to the user of the platform at the lowest zoom level, and depending on the number of yellow objects within the designated area of the map and the amount paid by the advertiser for this specific yellow object, the yellow object may also be shown at higher zoom levels. Yellow objects have all the information available in a white object, plus additional content including pictures, news, and a universal resource locator (URL) to access a website for the advertiser.

In addition to selling advertising, a booz master may also influence or provide content for their ‘virtual property’ defined by the boundaries of their booz. However, posted content must conform to the given standards formed by the platform operator or administrators. Posted content may include news, media (photos, video), messages, and objects but may not change shape or look and feel of the booz. In other words, all booz must have the same color conventions and icons to represent posted content and related functions.

As will be illustrated below with respect to the figures, the interactive GUI has a series of user selectable levels including objects, news, boozes, and media, as well as other functional features. At the level “Objects” booz masters as described above may place objects anywhere on the map indicating the seat of a business and add basic information about this business. This object will appear as a white icon or object. Advertisers may against payment of an advertising fee and in accordance with advertising terms of the platform place yellow objects anywhere on the map and add additional information. At the level “News” booz masters may place news items varying in importance from local to worldwide. The news will appear as a red icon on the platform GUI at map level “News”. Each member may become a booz master either by the initial assignment of a booz against the payment of an allocation fee or by means of transfer of the booz ownership from another booz master subject to the approval of platform administrators. At the level “Media” booz masters may upload and publish photographs of certain locations and place them on the GUI map. The GUI “office desktop” is an internal desktop for each member to organize their membership, personal details, and any other issues affiliated with their membership, as well as related financial statements (e.g., balance overviews and invoices).

It is noted that alternative color conventions for icons or objects within the platform may be used without changing the spirit of the invention

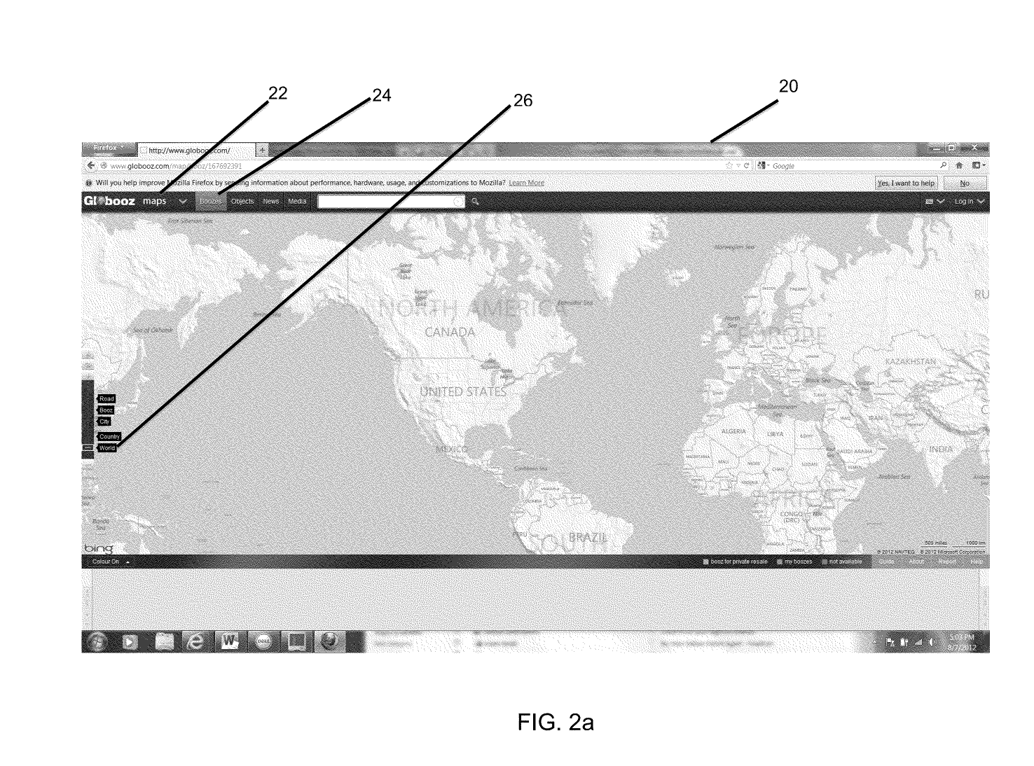

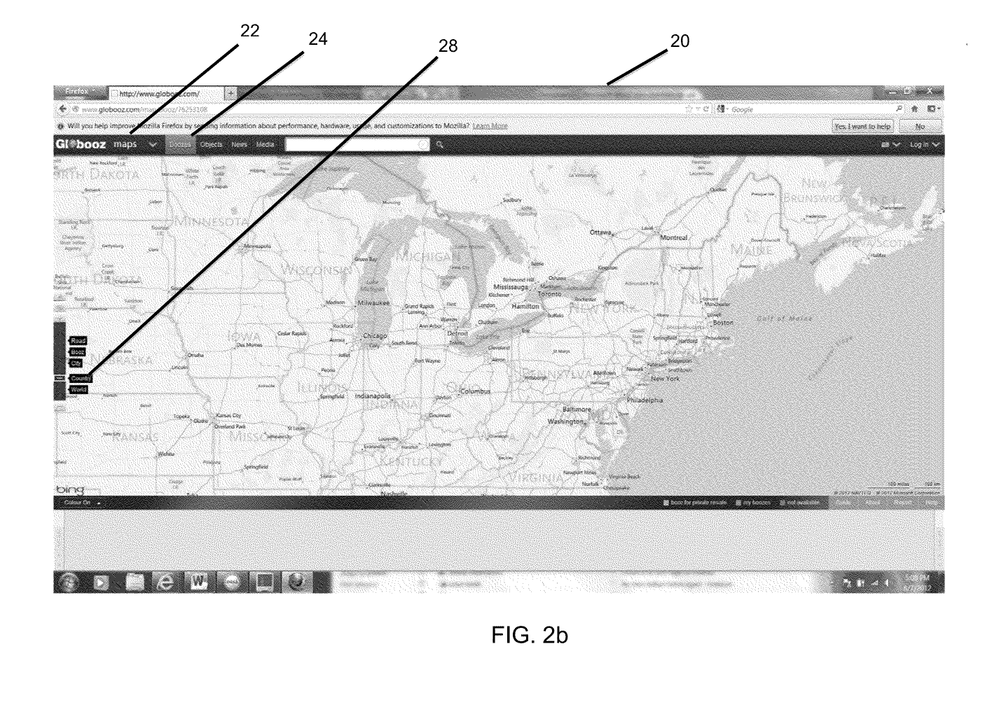

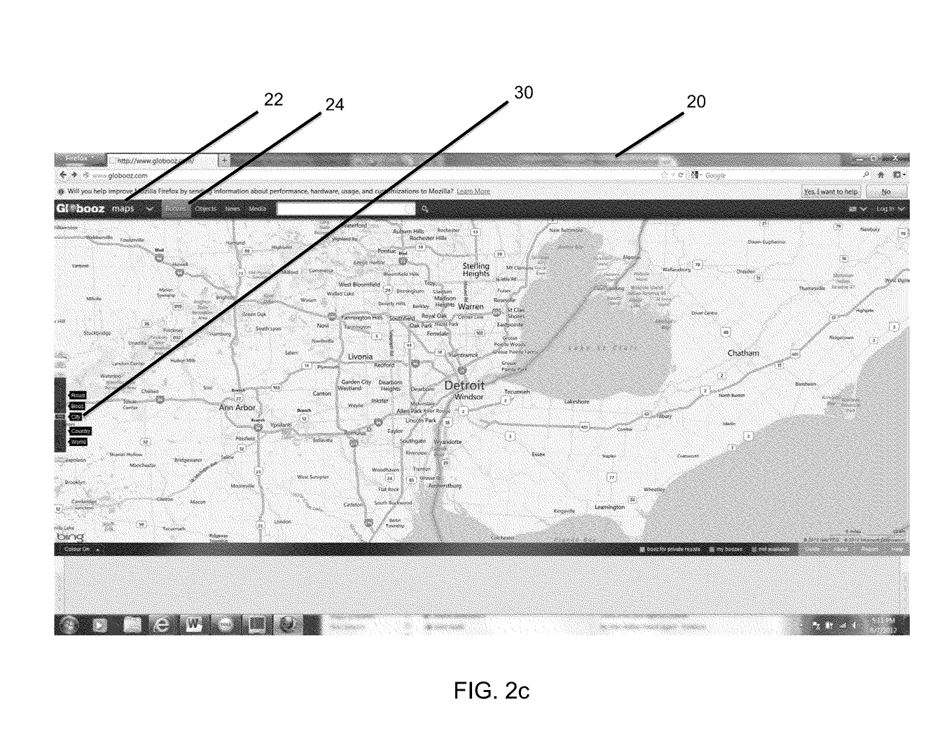

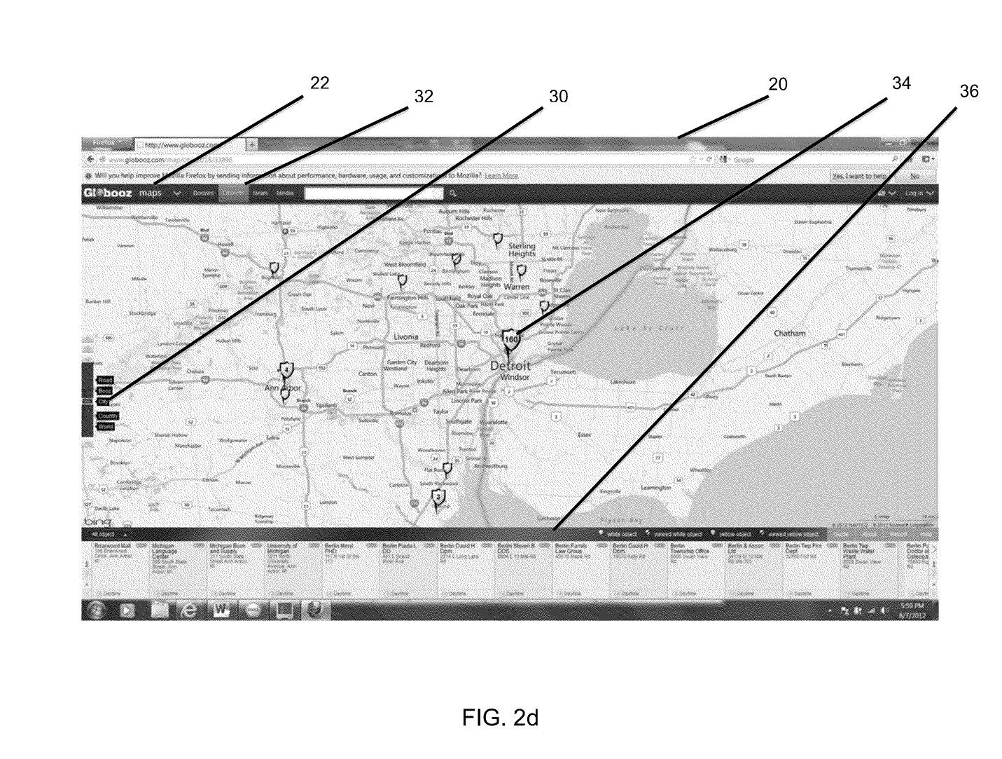

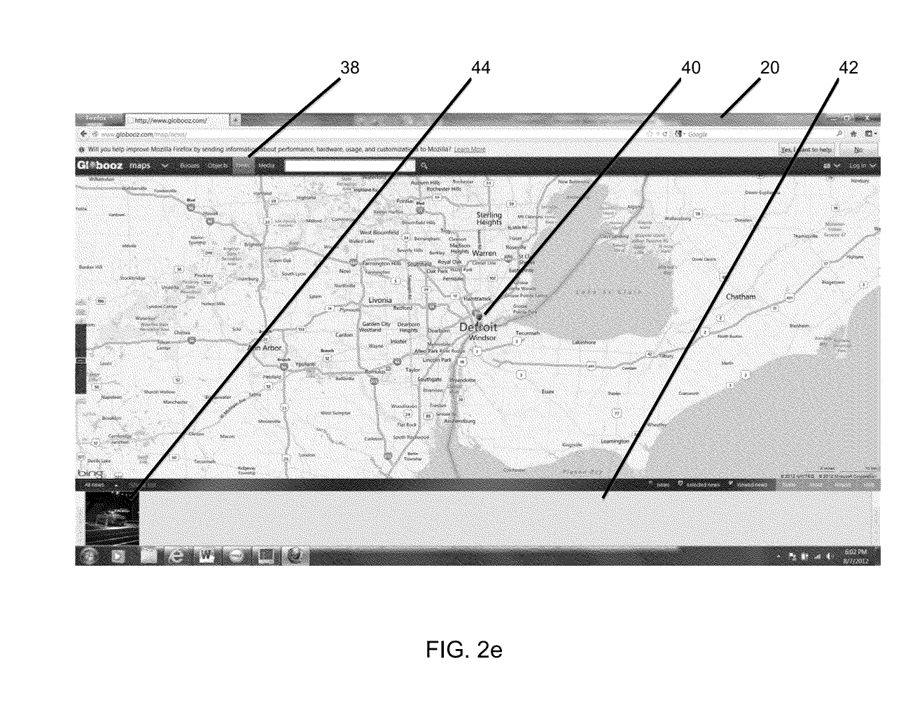

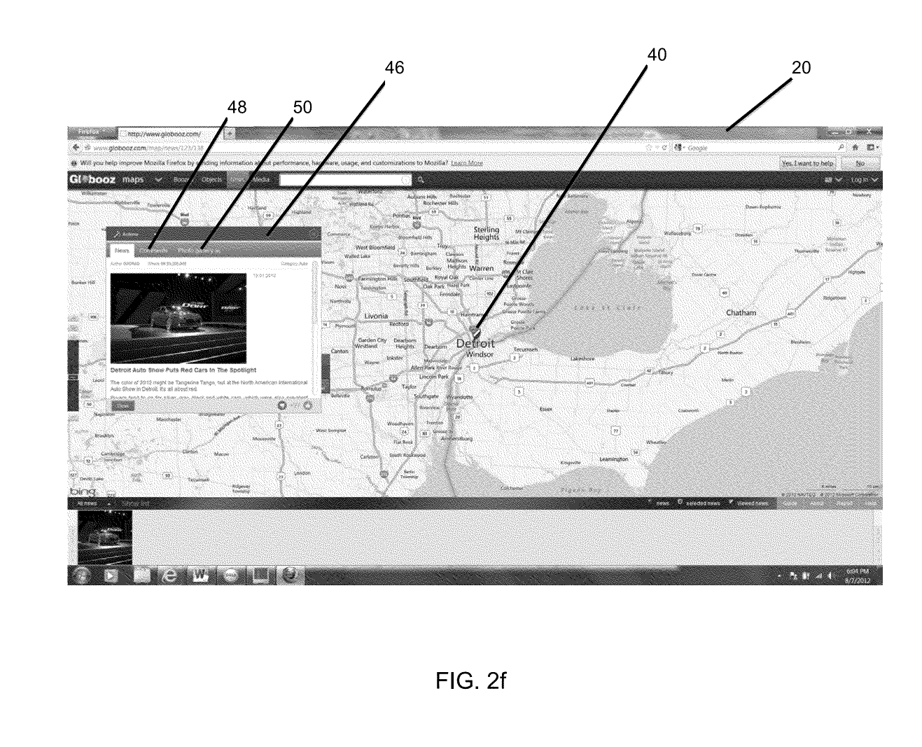

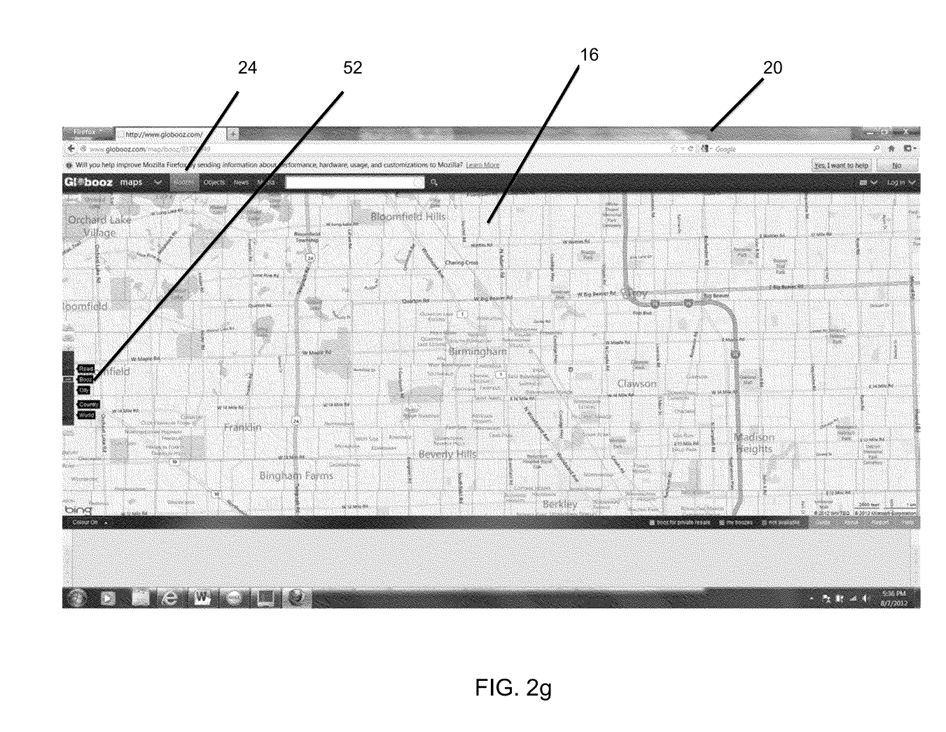

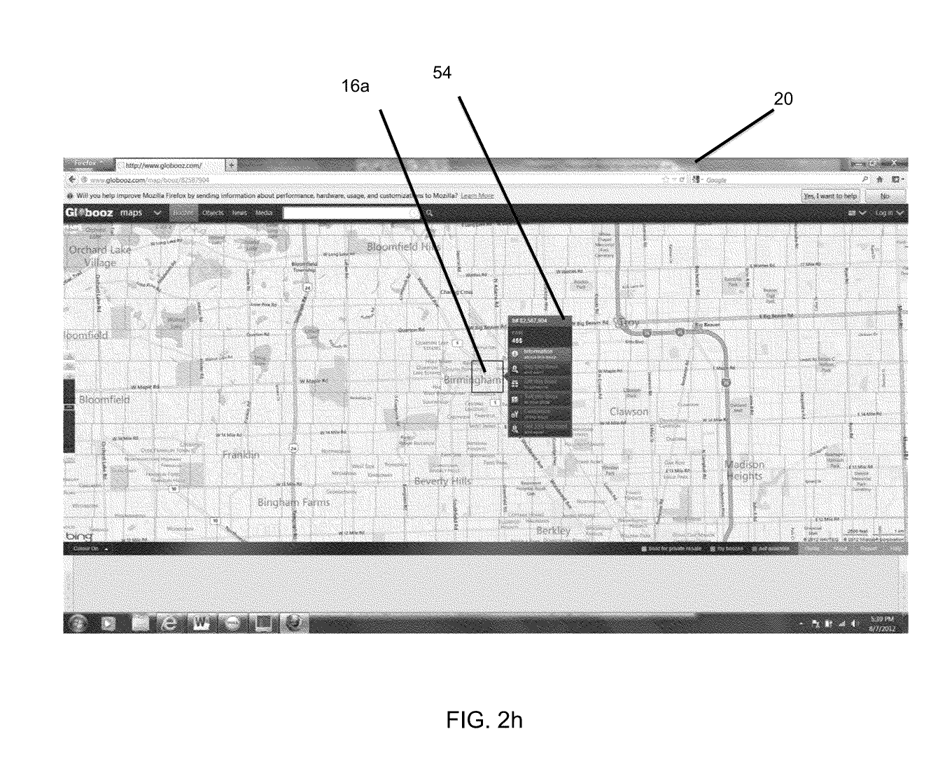

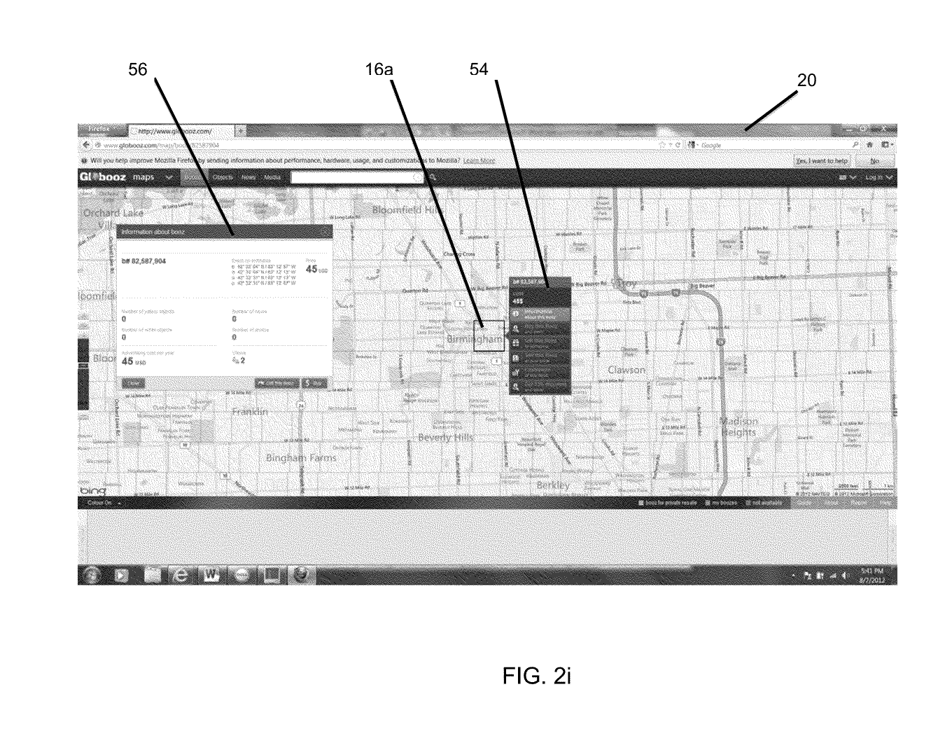

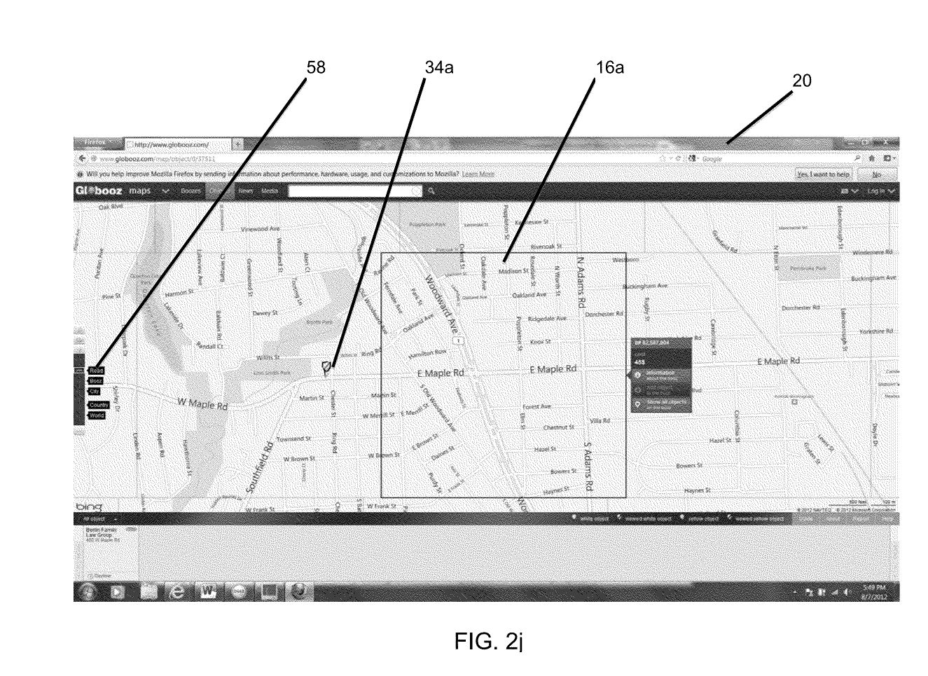

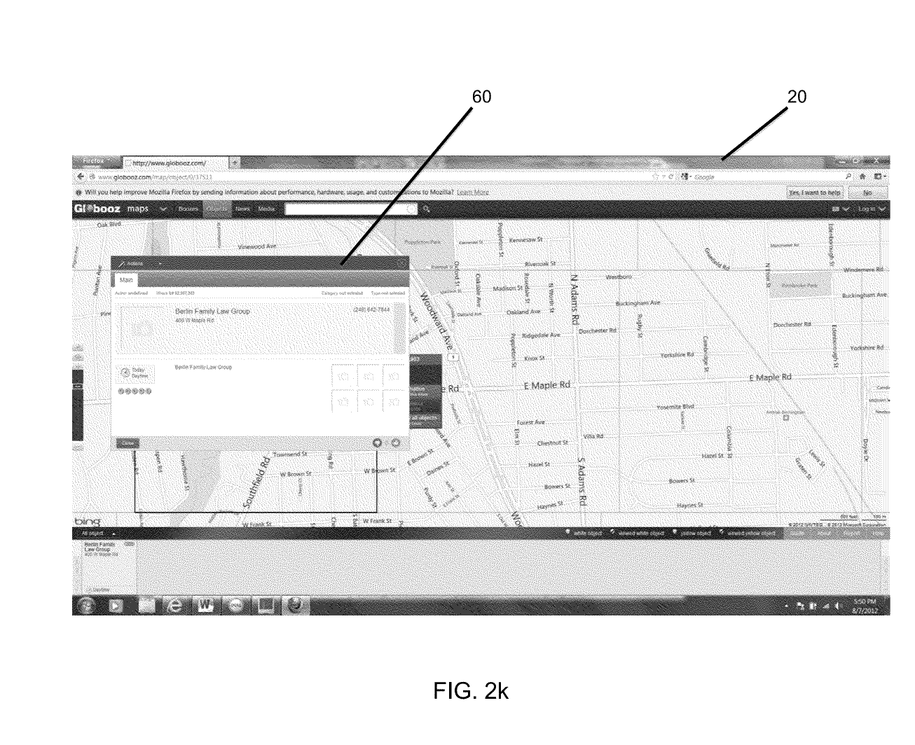

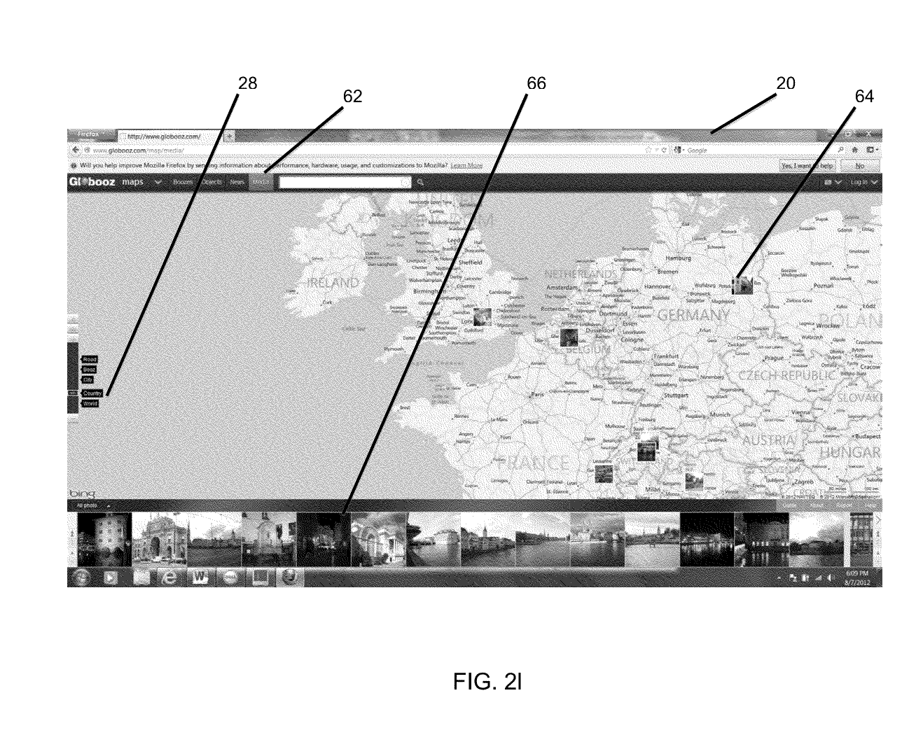

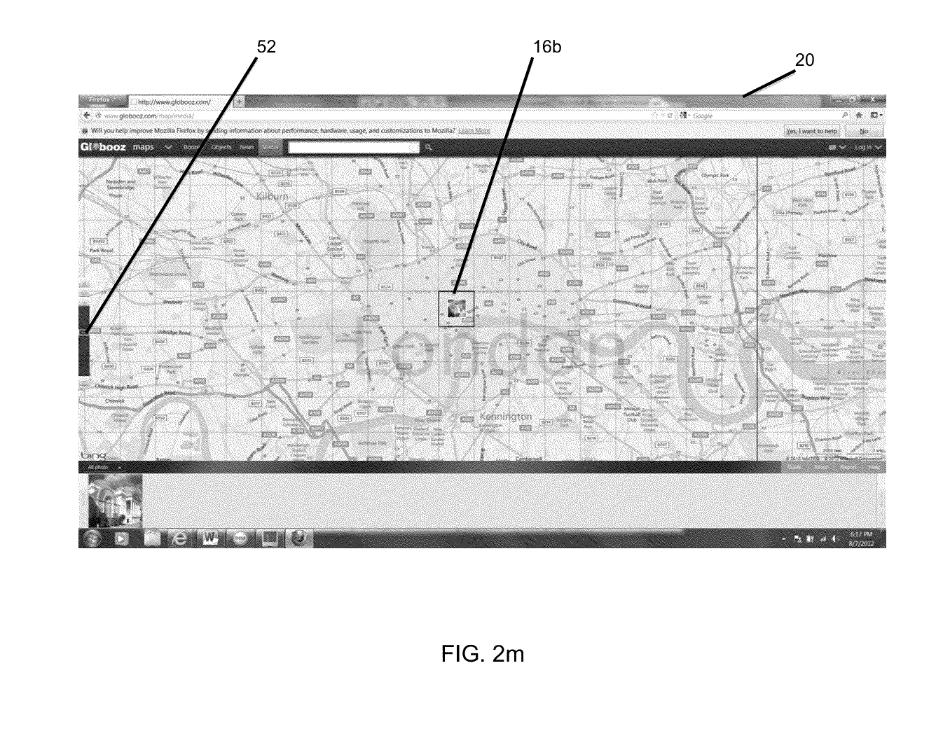

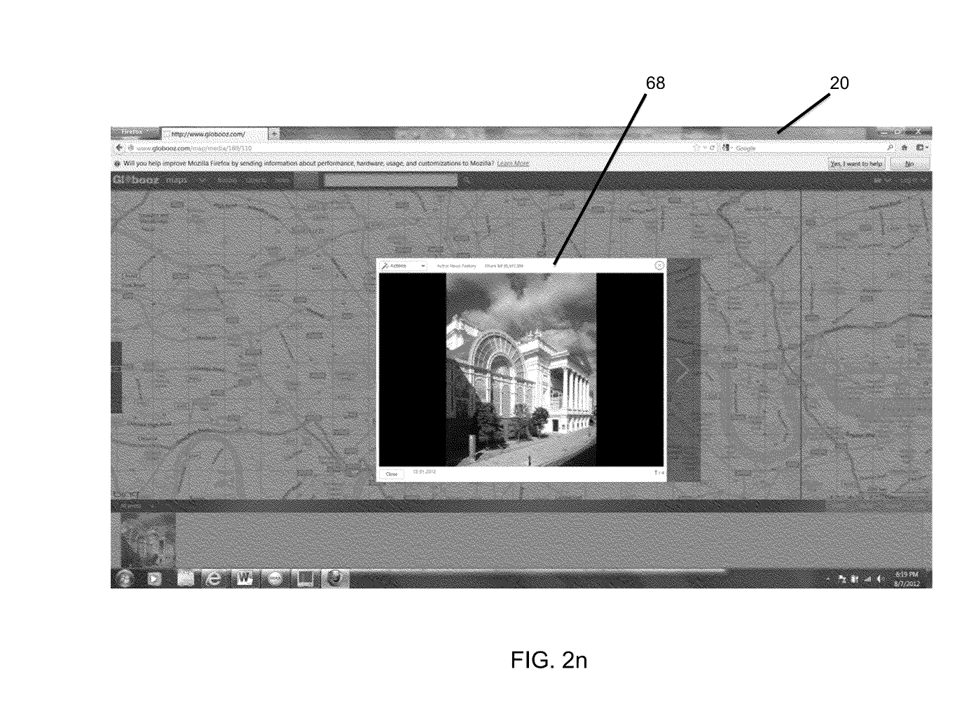

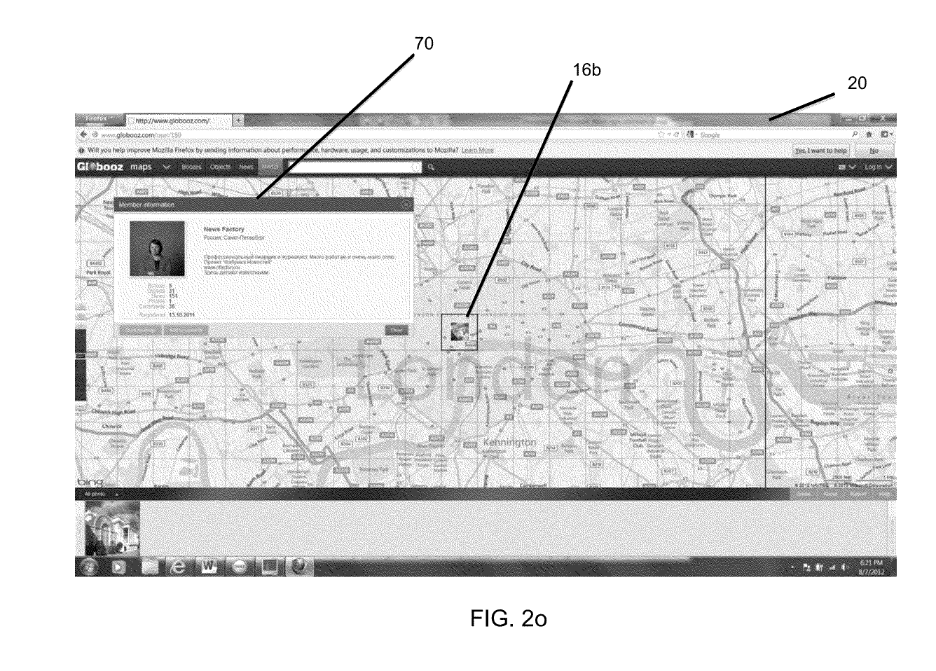

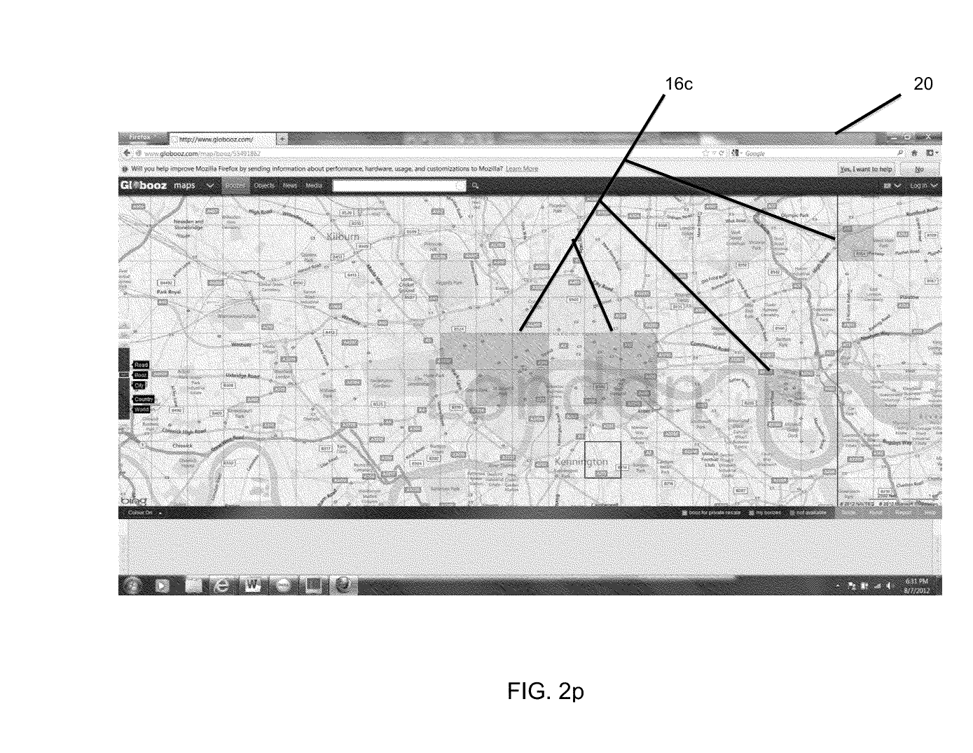

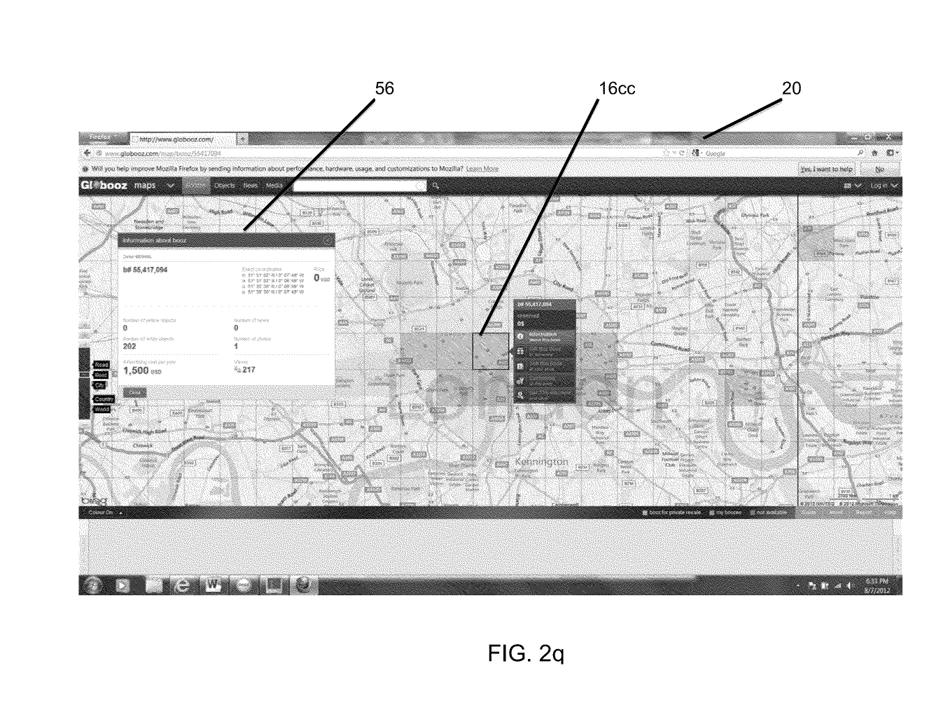

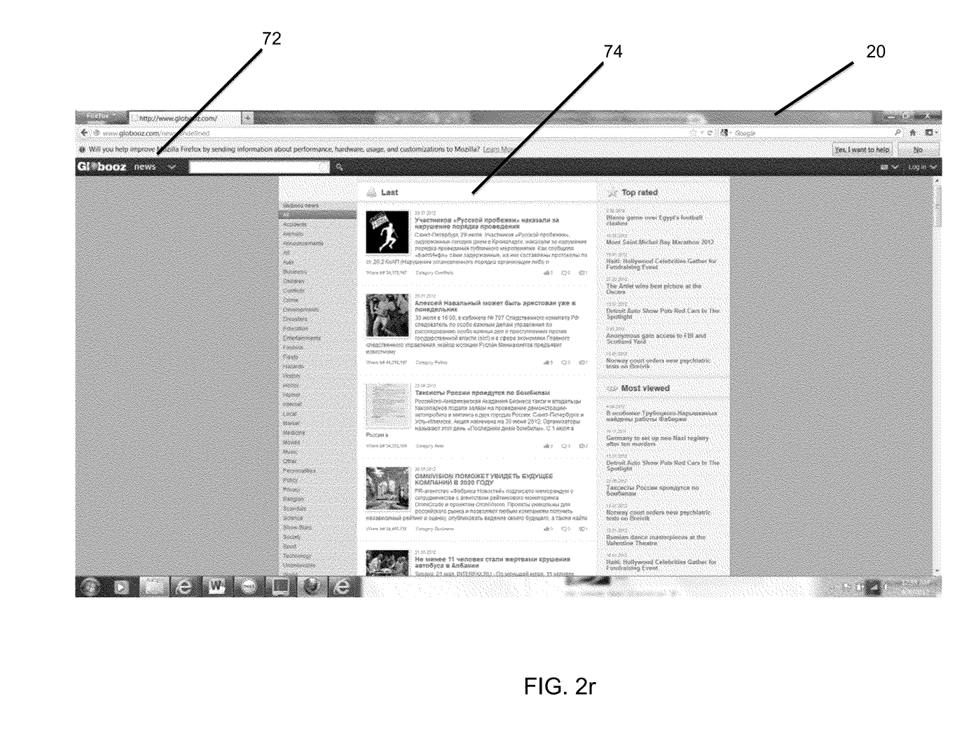

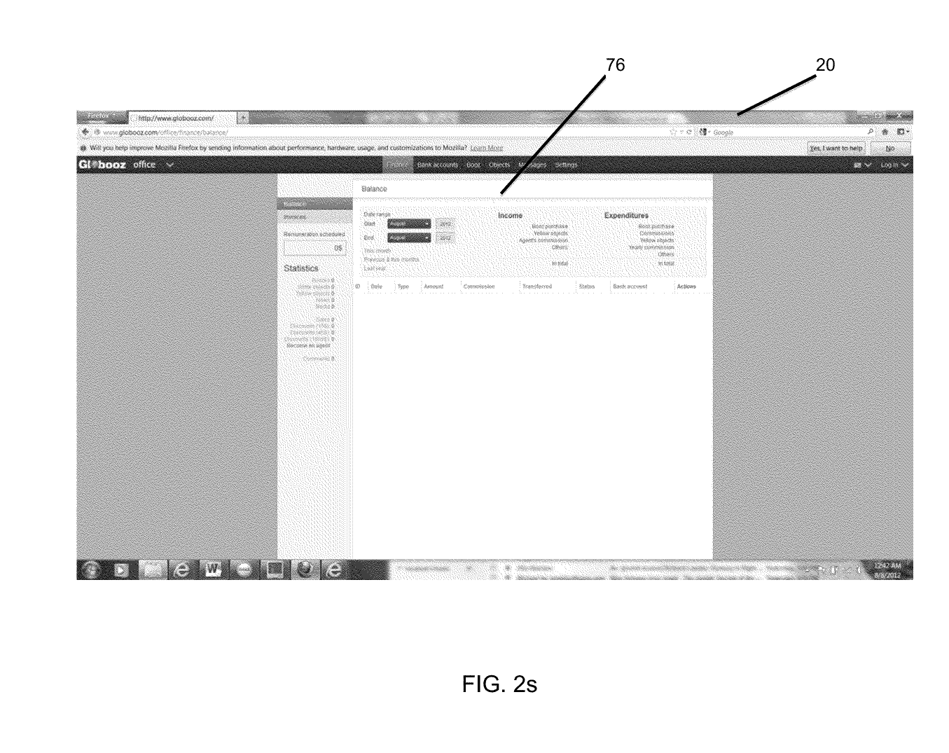

In other inventive embodiments, the platform has an underlying operating database including fields with the following information for each individual and unique booz: serial number of the booz; geo-coordinates of the corner points of the booz boundaries; initial price; assignment to a platform administrator or a member (booz master); precise time at which the assignment of a booz has been made; number of white objects; number of yellow objects; advertising costs; number of messages; number of photographs; the price, if any, quoted by the booz master at which they are willing to have the assignment of the booz changed. Certain pieces of information of the platform database are attached to each booz in the service platform map, level boozes and are publicly accessible to all members as will be shown in FIGS. 2a-2s.

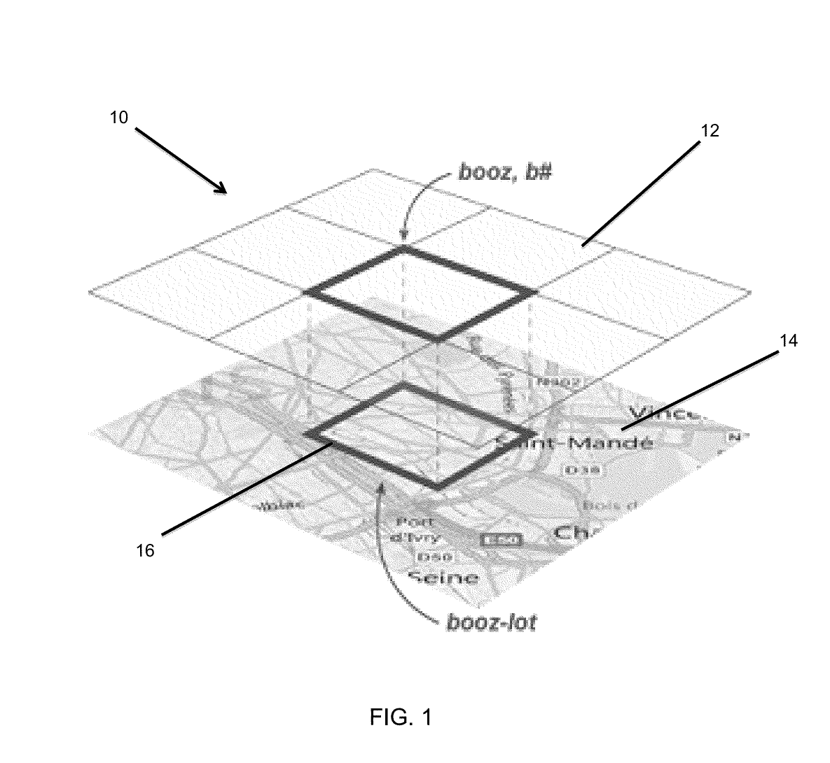

Referring now to the figures, FIG. 1 illustrates an exploded perspective view 10 of a geographic area 14 subdivided by a virtual overlay grid 12 defining territorial units in the form of a booz 16. As explained above, the virtual overlay grid 12 is used to subdivide a geographic area into equal virtual units that are available for purchase on the platform as boozes 16.

FIGS. 2a-2s illustrate a series of screen shots of an embodiment of a graphical user interface (GUI) 20 for implementing aspects of the invention. In FIG. 2a, the portal platform is accessed via the Internet as shown with a user interactive webpage GUI 20. It is noted that other networks and forms of access may be used to interact with the platform. The resolution of the view shown is at the user selectable “World” level 26 under the maps tab 22 with boozes tab 24 selected. In FIG. 2b, the resolution is increased, or zoomed into the user selectable “Country” level 28. In FIG. 2c, the resolution is increased further to the “City” level 30, which provides an overall view of a typical metropolitan area with a primary population center and accompanying suburban areas.

FIG. 2d illustrates the selection of the “Objects” tab 32 at the “City” level 30. In FIG. 2d, a number of white objects 34 are displayed. The numbers appearing inside the white objects 34 are the total number of objects within a booz. A booz located in a major city center or downtown area have a large number of white objects versus boozes in less densely populated areas or areas with a lower concentration of business. For example, a downtown area or central business district with several office buildings has many businesses concentrated in a relatively small area. Display bar 36 illustrates businesses associated with the white objects 34 that may be selected to gain further available information about the business. In FIGS. 2d and 2e, the “News” tab 38 is selected and a news icon 40 appears on the map of the GUI 20. In this instance, only a single news item 44 is available as shown in news bar 42. In FIG. 2f, news item 44 is selected or the corresponding news icon 40 is selected and the appearance changes to indicate the news icon 40 has been selected and/or read by the user and a more detailed news item pop up window 46 with the selected news item appears. The pop up window 46 has tabs for a comment section 48 and to view photos 50 related to the posted news item.

FIG. 2g illustrates the user selection of “Booz” level 52 with virtual overlay grid 12 defining territorial units in the form of boozes 16 subdividing the map view of the GUI 20. In FIG. 2h, a specific booz, (denoted by 16a) is selected by the user, and a pop up menu 54 with information about the selected booz appears. Information on the booz pop up 54 may include booz serial number, cost to purchase the booz, and other purchase, selling, and customization, features for the booz. In FIG. 2i, selection of “Information” within booz pop up 54 results in booz detail pop up 56 with a full listing of information for a selected booz including geographic coordinates delineating the borders of the selected booz 16a, booz serial number, number of yellow object, number of white objects, advertising cost, number of news items, number of photos, and views by users of the booz. FIG. 2j illustrates booz 16a at a “Street” level 58 resolution with “Object” tab 32 selected and one white object 34a visible outside the selected booz 16a. In FIG. 2k the white object 34a is selected with a detail pop up 60 of the white object 34a appearing in the GUI 20.

In FIG. 2l, the “Media” tab 62 is selected with the resolution at the user selectable “Country” level 28. Picture icons 64 appear where media content is available. Media bar 66 at the bottom of the GUI 20 displays the pictures of picture icons 64. FIG. 2m illustrates media at the “Booz” level 52 with a booz 16b with media content. FIG. 2n shows the booz 16b with the media content selected and enlarged as a media pop up 68. FIG. 2o illustrates member information 70 of a content (news or media) contributor. FIG. 2p illustrates boozes 16c that have been purchased as shaded. FIG. 2q illustrates booz detail pop up 56 with a full listing of information for a selected purchased booz 16cc in a similar fashion to FIG. 2I. In FIG. 2r, the “News” view 72 is selected and available stories 74 are listed. In FIG. 2s, the “Office” view is selected and a financial balance sheet and other account information is available to a booz master.

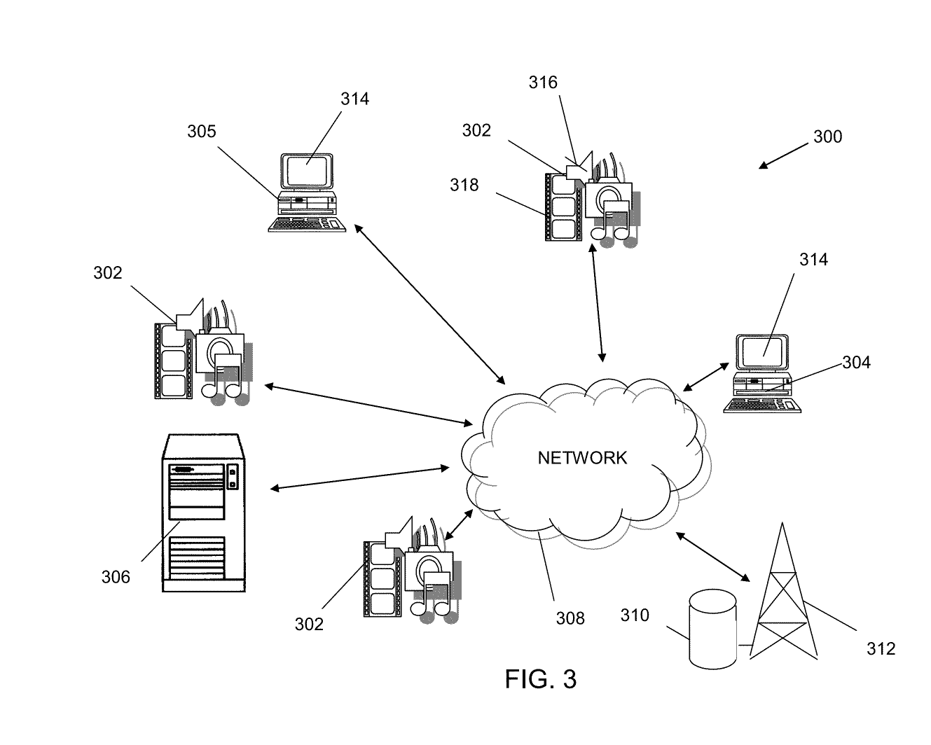

FIG. 3 is a schematic diagram illustrating an overall view of communication devices, computing devices, and mediums for implementing the platform according to embodiments of the invention. The elements of the embodiments of FIGS. 1 and 2A-2S are included in the networks and devices of FIG. 3.

The system 300 includes multimedia devices 302 and desktop computer devices 304 configured with display capabilities 314. The multimedia devices 302 are optionally mobile communication and entertainment devices, such as cellular phones and mobile computing devices that in certain embodiments are wirelessly connected to a network 308. The multimedia devices 302 typically have video displays 318 and audio outputs 316. The multimedia devices 302 and desktop computer devices 304 are optionally configured with internal storage, software, and a graphical user interface (GUI) for carrying out elements of the platform according to embodiments of the invention. The network 308 is optionally any type of known network including a fixed wire line network, cable and fiber optics, over the air broadcasts, satellite 320, local area network (LAN), wide area network (WAN), global network (e.g., Internet), intranet, etc. with data/Internet capabilities as represented by server 306. Communication aspects of the network are represented by cellular base station 310 and antenna 312. In a preferred embodiment, the network 308 is a LAN and each remote device 302 and desktop device 304 executes a user interface application (e.g., Web browser) to contact the server system 306 through the network 308. Alternatively, the remote devices 302 and 304 may be implemented using a device programmed primarily for accessing network 308 such as a remote client.

The software for the platform, of embodiments of the invention, may be resident on the individual multimedia devices 302 and desktop computers 304, or stored within the server 306 or cellular base station 310. Server 306 may implement a cloud-based service for implementing embodiments of the platform with a multi-tenant database for storage of separate client data.

The foregoing description is illustrative of particular embodiments of the invention, but is not meant to be a limitation upon the practice thereof. The following claims, including all equivalents thereof, are intended to define the scope of the invention.

1. A method for financial exchange comprising:
generating a plurality of boozes covering a target surface, each of a plurality of boozes occupies a predefined area of the surface and each of the plurality of boozes is contiguous with another of the plurality of boozes, the plurality of boozes collectively covers the entire target surface; and
exchanging ownership in at least one of the plurality of boozes as a financial exchange.

2. The method of claim 1 wherein the target surface comprises of surface covering planet Earth.

3. The method according to claim 2 wherein each of the plurality of boozes spans one degree measure along a latitude meridian and one degree measure along a longitude meridian as measured over the surface of the planet earth.

4. The method of claim 1 wherein each of the plurality of boozes has an owner wherein the owner is a business, organization or an individual.

5. The method of claim 1 further comprising defining a plurality of objects within one of the plurality of boozes.

6. The method of claim 5 wherein one of the plurality of objects is sold by an owner of one of the plurality of boozes containing the plurality of objects to a third party.

7. The method of claim 5 wherein an advertisement is sold by an owner that provides information about one of the plurality of objects.

8. The method of claim 1 further comprising an interactive graphical user interface (GUI) that has a series of user selectable levels, said selectable levels comprise objects, news, boozes, advertisements, media, as well as other functional features.

9. The method of claim 8 wherein said objects, news, boozes, advertisements, media, as well as other functional features are color coded.

10. A system comprising:
a predefined booz within a plurality of boozes, said plurality of boozes covers a target surface, each of said predefined booze of the plurality of boozes occupies a predefined area of the target surface, and each of the plurality of boozes is contiguous with another of the plurality of boozes, the plurality of boozes collectively covers the entire target surface;
a plurality of information items about each of said plurality of boozes;
software for the said plurality of boozes stored on a server or cellular base station;
a computer network supporting; and
at least one multimedia devices or desktop computer devices configured with display capabilities and connected to said network.

11. The system according to claim 10 wherein the plurality of information includes information regarding a business, organization, or an individual located within the predefined booz.

12. The system according to claim 10 wherein the plurality of information includes information of a news item related to the predefined booz.

13. The system according to claim 10 wherein the plurality of information includes information about an owner of the predefined booz where the owner has an ability to include or exclude information stored in the predefined booz.

14. The system according to claim 10 wherein the target surface comprises a surface covering planet Earth.

15. The system according to claim 14 wherein each of the plurality of boozes spans one degree measure along a latitude meridian and one degree measure along a longitude meridian as measured over the surface of the planet Earth.

16. The system according to claim 10 further comprising an interactive graphical user interface (GUI) that has a series of user selectable levels, said selectable levels include objects, news, boozes, advertisements, media or other functional features.

17. The system according to claim 16 wherein said objects, news, boozes, advertisements, media or other functional features are color coded.

18. A method for trading rights to a predefined booz comprising:
financially exchanging rights to the predefined booz between a booz owner and third party to add, delete, or change information within the predefined booz, where the predefined booz is within a plurality of boozes; said plurality of boozes cover a target surface, the predefined booz of the plurality of boozes occupies a predefined area of the target surface, and each of the plurality of boozes is contiguous with another of the plurality of boozes, the plurality of boozes collectively covers the entire target surface; and
changing a color designation of a locale within the predefined booz upon an advertiser paying a fee.

19. The method of claim 18 wherein the target surface comprises of a surface covering planet Earth.

20. The method of claim 18 further comprising entitling said booz owner to a percentage of revenue generated by advertising within the predefined booz.
